(19) United States
(12) Patent Application Publication
(10) Pub. No.: US 2018/0203925 A1
(43) Pub. Date: Jul. 19, 2018

(54) SIGNATURE-BASED ACOUSTIC CLASSIFICATION

(71) Applicant: ACOUSTIC PROTOCOL INC., Kensington, MD (US)

(72) Inventor: Nir Aran, Washington, DC (US)

(21) Appl. No.: 15/873,493

(22) Filed: Jan. 17, 2018

Related U.S. Application Data
(60) Provisional application No. 62/447,410, filed on Jan. 17, 2017.

(51) Int. Cl. G06F 17/30

(52) U.S. Cl. CPC G06F 17/30743; G06F 17/30598; G06F 17/30368

(57) ABSTRACT

A method for acoustic classification may include generating, based at least on one or more user inputs, a first association between an acoustic signature and a classification. The generation of the first association may include storing, at a database, the first association between the acoustic signature and the classification. A second association between the classification and an action may be generated including by storing, at the database, the second association between the classification and the action. An association between a sound and the classification can be determined based on the sound matching the acoustic signature. In response to the sound being associated with the classification, the action associated with the classification can be performed. Related systems and articles of manufacture, including computer program products, are also provided.

### RELATED APPLICATION

This application claims priority to U.S. Provisional Application No. 62/447,410 entitled SIGNATURE-BASED ACOUSTIC CLASSIFICATION and filed on Jan. 17, 2017, the disclosure of which is incorporated herein by reference in its entirety.

### TECHNICAL FIELD

The subject matter described herein relates generally to acoustic classifications and more specifically to a signature-based technique for acoustic classification.

### BACKGROUND

Sound amplification devices can have a multitude of useful applications. For example, personal sound amplification devices (PSAPs) may be used to boost volume in non-medical settings including, for example, hunting, bird watching, surveillance, and/or the like. By contrast, hearing aids are medical devices for the hearing-impaired. These sound amplification devices tend to have only rudimentary sound processing capabilities. For instance, some hearing aids may be configured to cancel noises, reduce noises, and/or selectively amplify and/or enhance frequencies based on known audiograms of an individual. Thus, while conventional sound amplification devices may be able to differentiate between sounds on an environmental level (e.g., vocal, music, room-tone, and/or the like), conventional sound amplification devices are generally unable to differentiate between sounds on a more granular level (e.g., door knock, dog bark). As such, conventional sound amplification deices may amplify sounds indiscriminately. Even within a limited range of audio frequencies, indiscriminate sound amplification can give rise to an overwhelming cacophony of sounds, most of which having no personal relevance to the user of the sound amplification device.

### SUMMARY

Systems, methods, and articles of manufacture, including computer program products, are provided for signature-based acoustic classification. In some example embodiment, there is provided a system that includes at least one processor and at least one memory. The at least one memory may include program code that provides operations when executed by the at least one processor. The operations may include: generating, based at least on one or more user inputs, a first association between a first acoustic signature and a first classification, the generation of the first association including storing, at a database, the first association between the first acoustic signature and the first classification; generating, based at least on the one or more user inputs, a second association between the first classification and a first action, the generation of the second association including storing, at the database, the second association between the first classification and the first action; determining, by at least on data processor, that a first sound is associated with the first classification based at least on the first sound matching the first acoustic signature; and in response to the first sound being associated with the first classification, performing the first action associated with the first classification.

In some variations, one or more features disclosed herein including the following features can optionally be included in any feasible combination. The first acoustic signature may include a first audio waveform. The determination that the first sound is associated with the first classification includes comparing a second audio waveform of the first sound against the first audio waveform of the first acoustic signature.

In some variations, the first sound may be determined to be associated with a second classification based at least on the first sound failing to match the first acoustic signature. A second action may be performed in response to the first sound being associated with the second classification.

In some variations, the second classification can designate the first sound as being unclassified. The second action can include disregarding the first sound. Alternatively and/or additionally, the first sound may be determined to be associated with the second classification further based at least on the first sound matching a second acoustic signature associated with the second classification. The second action may be associated with the second classification.

In some variations, an absence of a second sound corresponding to the first acoustic signature may be detected based at least on the first sound failing to match the first acoustic signature. In response to detecting the absence of the second sound, a second action may be performed. The second action may include triggering, at a device, an alert indicating the absence of the second sound.

In some variations, the first action may include triggering, at a device, an alert indicating a presence of the first sound. The alert may be a visual alert, an audio alert, and/or a haptic alert.

In some variations, the first action may include triggering, at a device, a modification of the first sound. The modification may include amplification, padding, and/or dynamic range compression.

In some variations, the first action may include sending, to a device, a push notification, an email, and/or a short messaging service (SMS) text message.

In some variations, a third association between the first classification and a second action may be generated based at least on the one or more user inputs. In response to the first sound being associated with the first classification, the first action may be performed at a first device and the second action may be performed at a second device.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many technical advantages. For example, the current subject matter provides a highly customizable technique for enhancing and/or supplementing audio signals. The current subject matter enables a differentiation between sounds that may relevant to a user and sounds that may be irrelevant to a user. Moreover, the sounds that are relevant to the user may trigger different actions than the sounds that are irrelevant to the user. As such, the user may only be alerted to sounds having personal relevance to the user and is therefore not overwhelmed by a cacophony of irrelevant sounds.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### DESCRIPTION OF DRAWINGS

FIG. 1A depicts a block diagram illustrating an acoustic classification system consistent with implementations of the current subject matter;

FIG. 1B depicts a block diagram illustrating an acoustic classification engine consistent with implementations of the current subject matter;

FIG. 2 depicts a feedback scale consistent with implementations of the current subject matter;

FIG. 3 depicts a screen shot of a user interface consistent with implementations of the current subject matter;

FIG. 4 depicts a flowchart illustrating a process for acoustic classification consistent with implementations of the current subject matter; and

FIG. 5 depicts a block diagram illustrating a computing system consistent with implementations of the current subject matter.

When practical, similar reference numbers denote similar structures, features, and/or elements.

### DETAILED DESCRIPTION

Due to an inability to differentiate between sounds on a granular level, conventional sound amplification devices (e.g., personal sound amplification devices (PSAPs), hearing aids, and/or the like) may amplify sounds indiscriminately. As such, conventional sound amplification devices may inundate users with a cacophony of different sounds, which may include irrelevant sounds that the users may wish to ignore. Various implementations of the current subject matter can prevent the indiscriminate amplification of sounds by differentiating between different sounds based on the corresponding acoustic signatures. For example, a signature-based acoustic classification system can be configured to recognize sounds having different acoustic signatures. Furthermore, the signature-based classification system can perform, based on the presence and/or the absence of a sound having a particular acoustic signature, one or more corresponding actions.

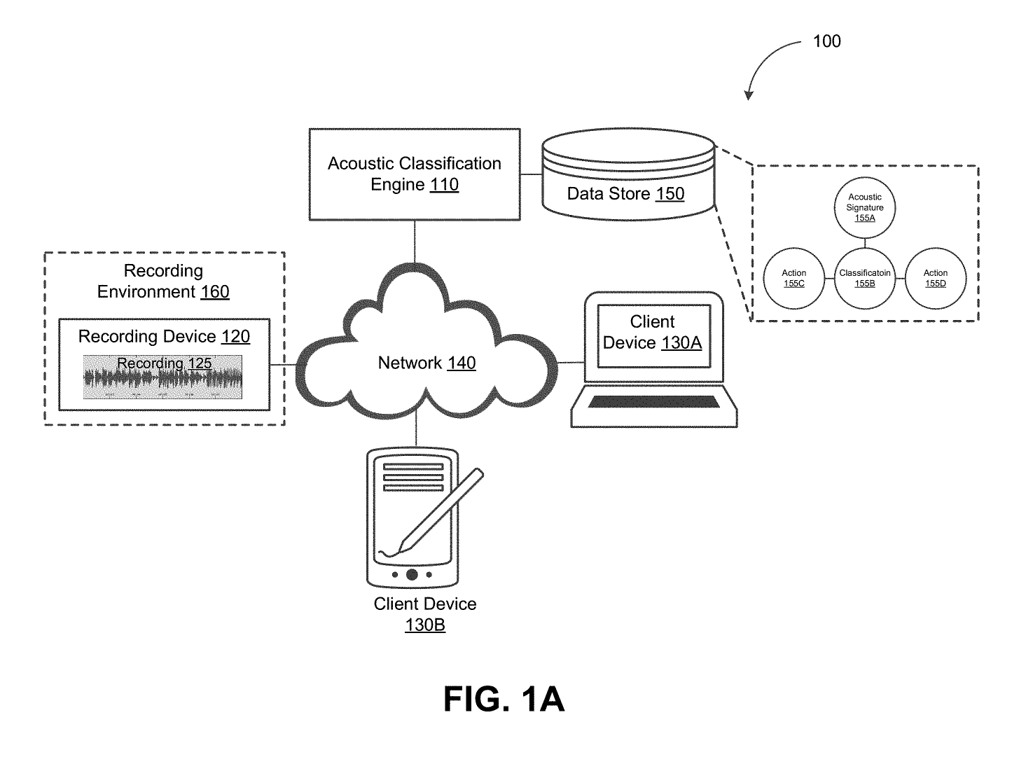

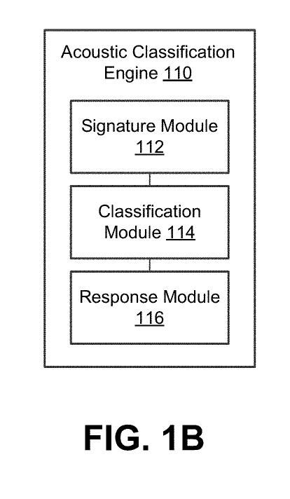

FIG. 1A depicts a block diagram illustrating an acoustic classification system 100 consistent with implementations of the current subject matter. Referring to FIG. 1A, the acoustic classification system 100 can include an acoustic classification engine 110, a recording device 120, a first client device 130A, and a second client device 130B. The first client device 130A can be associated with a user who require some form of sound amplification as provided, for example, by a personal sound amplification device (e.g., a hearing aid, a personal sound amplification device (PASP), a cochlear implant, an augmented hearing device, and/or the like). Alternatively and/or additionally, the second client device 130B can be associated with a third party associated with the user such as, for example, a caretaker, a friend, and/or a family of the user requiring sound amplification.

As shown in FIG. 1A, the acoustic classification engine 110 can be communicatively coupled, via a network 140, with the recording device 120, the first client device 130A, and/or the second client device 130B. The network 140 can be any wired and/or wireless network including, for example, a public land mobile network (PLMN), a wide area network (WAN), a local area network (LAN), a virtual local area network (VLAN), the Internet, and/or the like.

Referring again to FIG. 1A, the acoustic classification engine 110 can receive a recording 125 from the recording device 120. In some implementations of the current subject matter, the recording 125 can be any representation of a sound including, for example, an audio waveform and/or the like. Meanwhile, the recording device 120 can be any microphone-enabled device capable of generating an audio recording including, for example, a smartphone, a tablet personal computer (PC), a laptop, a workstation, a television, a wearable (e.g., smartwatch, hearing aid, and/or personal sound amplification device (PSAP)), and/or the like. It should be appreciated that the recording device 120 can also be a component within another device such as, for example, the first client device 130A and/or the second client device 130B. As shown in FIG. 1A, the recording device 120 may be deployed within a recording environment 160. As such, the recording 125 may exhibit one or more acoustic characteristics associated with the recording device 120 and/or the recording environment 160 (e.g., ambient noise).

The acoustic classification engine 110 can classify the recording 125, for example, by at least querying the data store 150 to identify a matching acoustic signature. In some implementations of the current subject matter, the data store 150 can store a plurality of acoustic signatures including, for example, an acoustic signature 155A. As used herein, an acoustic signature can refer to any representation of a corresponding sound including, for example, the distinct audio waveform associated with the sound. It should be appreciated that different sounds may give rise to different acoustic signatures. Furthermore, the same sound may also give rise to different acoustic signatures when the sound is recorded, for example, in different recording environments and/or using different recording devices.

The data store 150 may include any type of database including, for example, a relational database, a non-structured-query-language (NoSQL) database, an in-memory database, and/or the like. Thus, in order to retrieve one or more acoustic signatures from the data store 150, the acoustic classification engine 110 can execute one or more database queries (e.g., structured query language (SQL) statements). Furthermore, the acoustic classification engine 110 can determine whether the recording 125 match any of the acoustic signatures stored at the data store 150 (e.g., the acoustic signature 155A) by at least applying a comparison technique including, for example, pattern matching, statistical analysis, hash comparison, and/or the like. In some implementations of the current subject matter, the recording 125 may be determined to match an acoustic signature (e.g., the acoustic signature 155A) if a measure of similarity between the recording 125 and the acoustic signature exceeds a threshold value.

In some implementations of the current subject matter, each of the plurality of acoustic signatures stored in the data store 150 can be associated with a classification. To further illustrate, as shown in FIG. 1A, the acoustic signature 155A stored at the data store 150 can be associated with a classification 155B. The classification 155B can be assigned in any manner. For example, the user associated with the first client device 130A and/or the third-party (e.g., the user's caretaker, friend, and/or family member) associated with the second client device 130B can manually assign the classification 155B to the acoustic signature 155A. Alternatively and/or additionally, the classification 155B associated with the acoustic signature 155A can also be determined based on data gathered by a web crawler and/or through crowdsourcing.

The classification 155B associated with the acoustic signature 155A can be specific to the acoustic signature 155A and not shared with any other acoustic signatures. For example, the classification 155B can be “infant crying due to hunger,” which may only be applicable to the sound of an infant crying when the infant is hungry. Alternatively and/or additionally, the classification 155B associated with the acoustic signature 155A can be specific to a category of acoustic signatures that includes the acoustic signature 155A such that multiple acoustic signatures may all share the same classification. For instance, the classification 155B may be “pet noises,” which may apply to the sound of a dog bark, a cat meow, a bird chirp, and/or the like. Accordingly, different acoustic signatures and/or different categories of acoustic signatures can be differentiated based on the corresponding classifications.

As noted, acoustic classification engine 110 may determine that the recording 125 matches the acoustic signature 155A if a measure of similarity between the two (e.g., as determined by applying a comparison technique such as pattern matching, statistical analysis, hash comparison, and/or the like) exceeds a threshold value. By determining that the recording 125 received form the recording device 120 matches the acoustic signature 155A, the acoustic classification engine 110 can determine a classification for the recording 125 based on the classification 155B associated with the acoustic signature 155A. That is, based on the match between the recording 125 and the acoustic signature 155A, the acoustic classification engine 110 can determine that the recording 125 is also associated with the classification 155B. However, in some implementations of the current subject matter, the acoustic classification engine 110 can determine that the recording 125 does not match any of the acoustic signatures stored in the data store 150. When the recording 125 fails to match any of the acoustic signatures stored in the data store 150, the acoustic classification engine 110 can classify the recording 125 as unclassified. Alternatively and/or additionally, based on the failure to match the recording 125 to any of the acoustic signatures stored in the data store 150, the acoustic classification engine 110 can determine one or more sounds having the acoustic signatures stored in the data store 150 (e.g., the acoustic signature 155B) as being absent in the recording environment 160.

In some implementations of the current subject matter, each classification assigned to an acoustic signature and/or a category of acoustic signatures can further be associated with one or more actions. It should be appreciated that the classification assigned to an acoustic signature and/or a category of acoustic signatures can further correspond to a feedback class while the actions associated with the classification can correspond to types of feedback that are part of that feedback class. For example, as shown in FIG. 1A, the classification 155B assigned to the acoustic signature 155A can further be associated with a first action 155C and a second action 155D. As such, the acoustic classification engine 110 can trigger, based on the classification 155A being associated with the recording 125, the first action 155C and/or the second action 155D, for example, at the recording device 120, the first client device 130A, and/or the second client device 130B.

For example, the acoustic classification engine 110 can determine that the recording 125 is associated with the classification 155B based at least on the recording 125 matching the acoustic signature 155A. However, as noted, the acoustic classification engine 110 can also classify the recording 125 based at least on the recording 125 failing to match any one of the plurality of acoustic signatures stored at the data store 150. In the event the acoustic engine 110 determines that the recording 125 is associated with the classification 155B, the acoustic classification engine 110 can trigger the first action 155C and/or the second action 155D associated with the classification 155B. For instance, the first action 155C can be an alert including, for example, a visual alert, an audio alert, a haptic alert, and/or the like. Meanwhile, the second action 155D can include an audio modification applied to the recording 125 including, for example, amplification, padding, dynamic range compression (DRC), and/or the like. It should be appreciated that the acoustic classification engine 110 can trigger the same and/or different actions (e.g., the first action 155C and/or the second action 155D) at different devices. For instance, the acoustic classification engine 110 may trigger the first action 155C at the first client device 130A and trigger the second action 155D at the second client device 130B. Alternatively and/or additionally, the acoustic classification engine 110 may trigger the first action 155C and/or the second action 155D at both the first client device 130A and the second client device 130B.

In some implementations of the current subject matter, the acoustic classification engine 110 can be deployed locally and/or remotely to provide classification of sounds and/or the trigger the performance of one or more corresponding actions. For instance, the acoustic classification engine 110 may be provided as computer software and/or dedicated circuitry (e.g., application specific integrated circuits (ASICs)) at the recording device 120, the first client device 130A, and/or the second client device 130B. Alternately and/or additionally, some or all of the functionalities of the acoustic classification engine 110 may be available remotely via the network 140 as, for example, a cloud based service, a web application, a software as a service (SaaS), and/or the like. Here, some or all of the functionalities of the acoustic classification engine 110 may be available via, for example, a simple object access protocol (SOAP) application programming interface (API), a representational state transfer (RESTful) API, and/or the like.

FIG. 1B depicts a block diagram illustrating the acoustic classification engine 110 consistent with some implementations of the current subject matter. Referring to FIG. 1B, the acoustic classification engine 110 may include a signature module 112, a classification module 114, and a response module 116. It should be appreciated that the acoustic classification engine 110 may include additional and/or different modules than shown.

In some implementations of the current subject matter, the signature module 112 can be configured to associate an acoustic signature with a classification such as, for example, the acoustic signature 155A with the classification 155B. Furthermore, the signature module 112 can associate the classification with one or more actions such as, for example, the classification 155B with the first action 155C and/or the second action 155D. The classification module 114 can determine that the recording 125 received at the acoustic classification engine 110 matches the acoustic signature 155A. As such, the classification module 114 can determine that the recording 125 received at the acoustic classification engine 110 is also associated with the same classification 155B. In response to the classification module 114 determining that the recording 125 is associated with the classification 155B, the response module 116 can trigger the first action 155C and/or the second action 155D associated with the classification 155B. As noted, the classification 155B can correspond to a feedback class while the first action 155C and/or the second action 155D may be the types of feedback included in that feedback class.

To further illustrate, the signature module 112 can receive a sound recording that corresponds to a specific sound such as, for example, the sound of a dog bark, the sound of an infant crying due to hunger, and/or the sound of an infant crying due to illness. The signature module 112 can receive the sound recording from any microphone-enabled device capable of generating an audio recording such as, for example, the recording device 120. As noted, the recording device 120 may be a smartphone, a tablet personal computer (PC), a laptop, a workstation, a television, a wearable (e.g., smartwatch, hearing aid, and/or personal sound amplification device (PSAP)), and/or the like. Here, the signature module 112 may extract, from the sound recording, the acoustic signature 155, which may be any representation of the corresponding sound including, for example, an audio waveform of the sound.

As noted, the classification 155B can be assigned to the acoustic signature 155A manually by a user associated with the first client device 130A and/or a third-party associated with the second client device 130B. The user may require some form of sound amplification as provided, for example, by a sound amplification device (e.g., hearing aid, personal sound amplification device (PASP), cochlear implant, augmented hearing device, and/or the like) while the third-party may be the user's caretaker, friend, and/or family member. Alternatively and/or additionally, the classification 155B can also be determined based on data collected by web crawlers and/or through crowdsourcing. Nevertheless, it should be appreciated that the user and/or the third-party may have personal experience that enables the assignment of a more nuanced classification to the acoustic signature 155A than, for example, conventional machine learning based sound recognition techniques. In particular, the user and/or the third-party may be able to identify sounds having personal significance to the user. For instance, the user and/or the third-party may be able to differentiate between the sound of the user's dog barking, the sound of a neighbor's dog barking, and/or the sound of a generic dog bark. Similarly, the user and/or the third-party may be able to differentiate between the sound of the user's infant crying due to hunger and the sound of the user's infant crying due to illness. Here, the signature module 112 may be configured to harness the user's and/or the third-party's personal knowledge in associating acoustic signatures with classifications that are specific to and/or have personal significance to the user. Moreover, the sound recordings received by the signature module 112 may be made in the user's personal environment (e.g., the recording environment 160) and may therefore include acoustic characteristics (e.g., ambient noises) unique to that environment.

In some implementations of the current subject matter, the signature module 112 can be further configured to associate the classification 155B with the first action 155C and/or the second action 115D, which may be performed by the response module 116 in response to the presence and/or the absence of a sound having the acoustic signature 155A. Again, as noted, the classification 155B may correspond to a feedback class while the first action 155C and/or the second action 155B may be the types of feedback associated with that feedback class. For example, the classification module 114 may determine that the recording 125 received at the acoustic classification engine 110 matches the acoustic signature 155 associated with the classification 155B. Accordingly, the response module 116 can trigger the first action 155C and/or the second action 155D. The first action 155C may be an alert (e.g., audio, visual, haptic, and/or the like), which may be triggered at the recording device 120, the first device 130A, and/or the second device 130B in response to the recording 125 matching the acoustic signature 155. For example, the user and/or the third party (e.g., the user's caretaker, dog walker, and/or the like) may be notified whenever the acoustic classification engine 110 detects a sound having the acoustic signature 155. Alternatively and/or additionally, the second action 155D may be an audio modification (e.g., amplification, padding, dynamic range compression (DRC), and/or the like) applied to the recording 125, for example, by the user's sound amplification device (e.g., hearing aid, personal sound amplification device (PASP), cochlear implant, augmented hearing device, and/or the like). For instance, the sound of a kiss on the user's cheeks may be excessively loud due to the proximity of the sound source to the user's sound amplification device. As such, the second action 155D associated with the classification 155B may be padding to decrease the volume of the recording 125 if the classification 155B associated with the recording 125 corresponds to the sound of a kiss on the user's cheek.

In some implementations of the current subject matter, the classification module 114 can be configured to classify one or more recordings received at the acoustic classification engine 110. For example, the classification module 114 may receive the recording 120 and may classify the recording 120 by comparing the recording to one or more acoustic signatures stored in the data store 150 including, for example, the acoustic signature 155. Each acoustic signature stored in the data store 150 can correspond a sound such as, for example, dog barking, infant crying, and/or the like. The classification module 114 can compare the recording 120 to the acoustic signatures stored in the data store 150 using any comparison techniques including, for example, pattern matching, statistical analysis, hash comparison, and/or the like. In doing so, the classification module 114 can determine that the recording 125 is associated with the classification 155B based at least on the recording 125 being matched to the acoustic signature 155A associated with the classification 155B. However, as noted, the classification module 114 can also classify the recording 125 based on the recording 125 failing to match any of the acoustic signatures stored in the data store 150.

In some implementations of the current subject matter, the response module 116 can be configured to perform and/or trigger the performance of one or more actions based on the classification determined for a recording. For example, as noted, the classification 155B may be associated with the first action 155C and/or the second action 155D, which may be performed whenever the classification engine 114 determines that a recording (e.g., the recording 125) received at the acoustic classification engine 110 matches the acoustic signature 155A. The response module 116 can be configured to perform and/or trigger the performance of the first action 155C and/or the second action 155D, for example, at the recording device 120, the first client device 130A, and/or the second client device 130B.

According to some implementations of the current subject matter, the first action 155C may include, for example, the provision of an alert (e.g., audio, visual, haptic, and/or the like) indicating that a certain sound (e.g., the user's dog barking, the user's infant crying) has been detected by the acoustic classification engine 110. Referring again to FIG. 1A, the response module 116 can be configured to perform the first action 155C by sending, to the first device 130A and/or the second device 130B, a push notification, an email, and/or a short messaging service (SMS) text message, in response to the acoustic classification engine 110 encountering a sound (e.g., the recording 120) that the classification module 114 associates with the classification 155B. Alternately and/or additionally, the second action 155D can include one or more audio modifications including, for example, amplification, padding, dynamic range compression (DRC), and/or the like. For instance, in some implementations of the current subject matter, the response module 116 can respond to the detection of certain sounds (e.g., the sound of a kiss on the cheek) by adjusting the audio modifications applied to those sounds, for example, by a sound amplification device (e.g., hearing aid, personal sound amplification device (PASP), cochlear implant, augmented hearing device, and/or the like). It should be appreciated that the response module 116 can perform and/or trigger the performance of one or more actions via any channel including, for example, radio signaling, non-radio signaling, application programming interfaces (APIs), and/or the like.

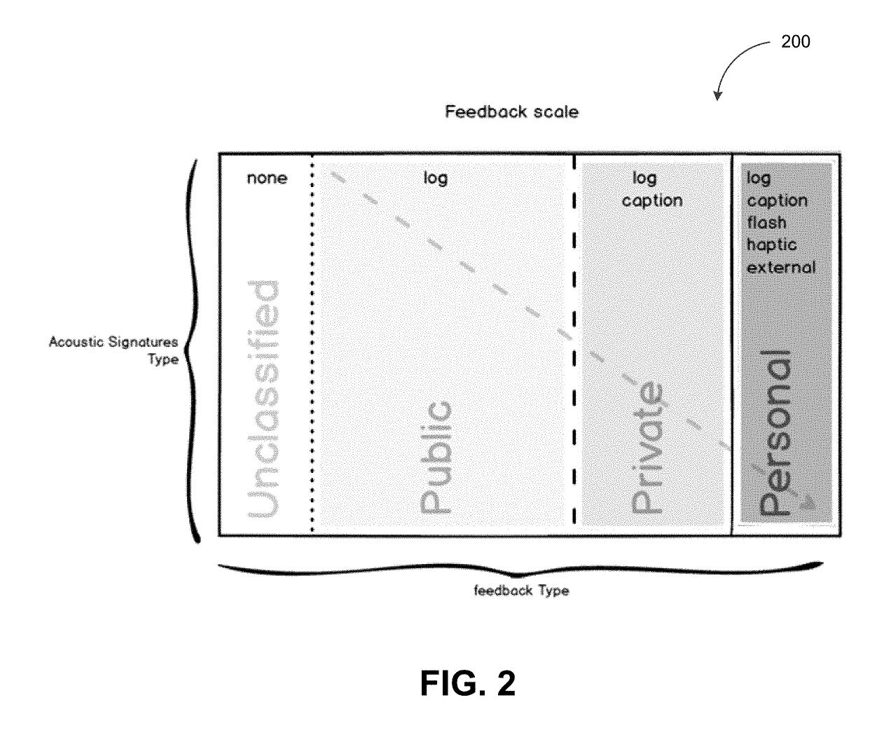

FIG. 2 depicts a feedback scale 200 consistent with implementations of the current subject matter. As noted, according to some implementations of the current subject matter, the response to the detection of a sound may vary based on the classification of the sound (e.g., as determined by the classification module 114). Referring to FIG. 2, the feedback scale 200 may include a plurality of feedback classes for different acoustic signatures including, for example, unclassified acoustic signatures, public acoustic signatures, private acoustic signatures, and personal acoustic signatures. Each type of acoustic signature may trigger different types of feedback from the acoustic classification engine 110.

As used herein, a feedback may include one or more actions performed and/or triggered by at acoustic classification engine 110, for example, by the response module 116. Furthermore, as noted, a feedback class may correspond to the classification that classification module 114 may associate with a sound received at the acoustic classification engine 110. Referring again to FIG. 2, the types and/or magnitude of feedback may increase when the personal significance of the acoustic signature increases. Thus, unclassified acoustic signatures may trigger little or no feedback while more personal acoustic signatures may trigger a larger number of and/or more substantial feedback.

To further illustrate, when the classification module 114 determines that the recording 120 does not match any known acoustic signatures (e.g., from the data store 110) and therefore classifies the recording 120 as having an unclassified acoustic signature, the response module 116 may be configured to perform no action in response to the recording 120 which may include, for example, disregarding the recording 120. By contrast, when the classification module 114 determines that the recording 120 matches one or more public acoustic signatures (e.g., car honks on the street) and therefore classifies the recording 120 as having a public acoustic signature, the response module 116 may log the occurrence of the audio event. Meanwhile, when the classification module 114 determines that the recording 120 matches one or more private acoustic signatures (e.g., water running in the kitchen) and classifies the recording 120 as having a private acoustic signature, the response module 116 may both log the occurrence of the audio event and also generate a corresponding caption that can be displayed at the recording device 120, the first device 130A, and/or the second device 130B. Alternately and/or additionally, when the classification module 114 determines that the recording 120 matches one or more personal acoustic signatures (e.g., the user's name being called) and classifies the recording 120 as having a personal acoustic signature, the response module 116 may perform additional actions including, for example, logging the occurrence of the audio event, generating a corresponding caption, and/or triggering one or more alerts at the recording device 120, the first device 130A, and/or the second device 130B.

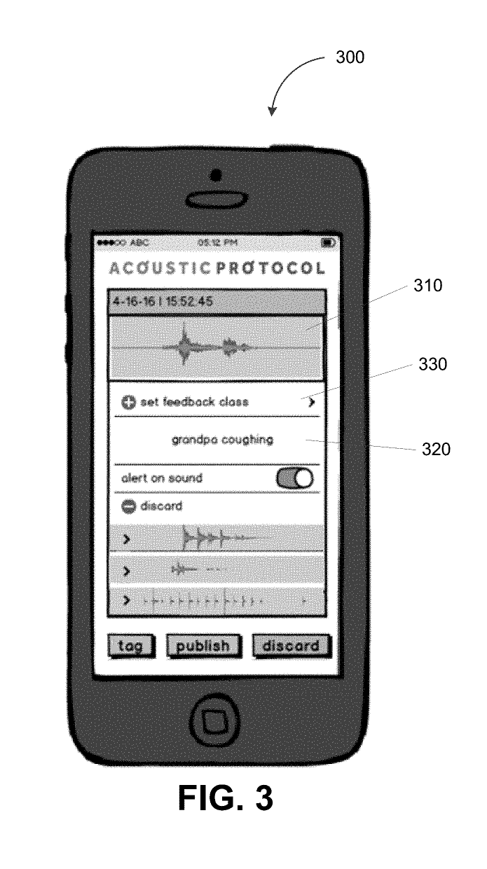

FIG. 3 depicts a screen shot of a user interface 300 consistent with implementations of the current subject matter. Referring to FIG. 3, the user interface 300 may be displayed at the recording device 120, the first device 130A, and/or the second device 130B to enable a user and/or a third-party (e.g., the user's caretaker, friend, and/or family member) to associate an acoustic signature with a classification and one or more actions. For instance, as shown in FIG. 3, the user interface 300 can display an audio waveform 310 of a sound which may, in some implementations of the current subject matter, correspond to the acoustic signature of the sound. The user can associate the audio waveform 310 with an identification 320 (e.g., “grandpa coughing”). Furthermore, the user can associate the audio wave form 130 with a classification 330, which may correspond to a feedback class that includes one or more types of feedback (e.g., actions). In doing so, the user can associate the sound of “grandpa coughing” with a feedback class such that the detection of the sound of “grandpa coughing” can trigger the feedback (e.g., actions) included in the feedback class. For instance, referring to FIGS. 2-3, the user can assign the sound of “grandpa coughing” to the private acoustic signature class in the feedback scale 200. In doing so, the user can configure the acoustic classification engine 110 (e.g., the response module 116) to respond to the sound of “grandpa coughing” by at logging and captioning the audio event. Alternately, if the user assigns the sound of “grandpa coughing” to the personal acoustic signature class in the feedback scale 200, the acoustic classification engine 110 (e.g., the response module 116) can respond to the sound of “grandpa coughing” by logging the audio event, captioning the audio event, and providing one or more alerts.

In some implementations of the current subject matter, the acoustic classification engine 110 can be configured detect and respond to negative acoustic events such as when the acoustic classification engine 110 does not encounter a particular sound for a period time. For instance, the acoustic classification engine 110 can be configured to detect when the acoustic classification engine 110 (e.g., the classification module 114) has not encountered a recording matching the acoustic signature for the sound of “grandpa coughing” for a predetermined period of time (e.g., 24 hours) and perform (e.g., via the response module 116) one or more corresponding actions (e.g., alerts).

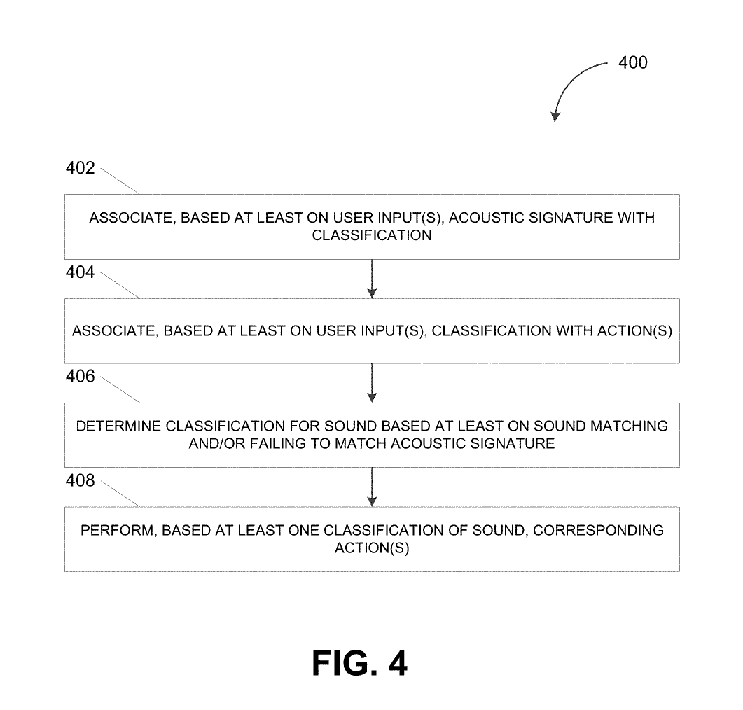

FIG. 4 depicts a flowchart illustrating a process 400 for acoustic classification consistent with implementations of the current subject matter. Referring to FIGS. 1-4, the process 400 can be performed by the acoustic classification engine 110.

The acoustic classification engine 110 can associate, based at least on one or more user inputs, an acoustic signature with a classification (402). For example, the acoustic classification engine 110 (e.g., the signature module 112) can associate the acoustic signature 155A with the classification 155B based on one or more inputs from a user and/or a third-party who, as noted, may provide a nuanced classification that differentiates sounds having the acoustic signature 155A from similar and/or more generic sounds. For instance, the acoustic classification engine 110 may be able to associate the acoustic signature 155A with the classification 155B indicating that the acoustic signature 155A corresponds to the sound of the user's dog barking. By contrast, conventional machine learning classification techniques are merely configured to provide generic classifications and cannot differentiate between, for example, the sound of the user's dog barking and the generic sound of a dog bark. In some implementations of the current subject matter, the acoustic classification engine 110 may associate the acoustic signature 155A with the classification 155B by at least storing, in the data store 150, an association between the acoustic signature 155A and the classification 155B.

The acoustic classification engine 110 can associate, based at least on the one or more user inputs, the classification with one or more actions (404). In some implementations of the current subject matter, the acoustic classification engine 110 may further associate the classification 155B with the first action 155C and/or the second action 155D, which may be performed whenever the acoustic classification engine 110 detects a sound having the acoustic signature 155A. The acoustic classification engine 110 can associate the classification 155B with the first action 155C and/or the second action 155D by at least storing, in the data store 150, an association between the classification 155B and the first action 155C and/or the second action 155D. For example, the first action 155C and/or the second action 155D can include providing an alert to a user and/or a third party associated with the user (e.g., dog walker, caregiver) whenever the acoustic classification engine 110 detects a sound having a particular classification. Alternately and/or additionally, these actions may include one or more audio modifications (e.g., amplification, padding, dynamic range compression (DRC), and/or the like) that the user's sound amplification device can apply to a sound having a particular classification (e.g., a kiss on the cheek).

The acoustic classification engine 110 can determine a classification for a sound based at least on the sound matching and/or failing to match the acoustic signature (406). For example, the acoustic classification engine 110 (e.g., the classification module 114) may classify a sound by comparing the corresponding recording 120 to one or more known acoustic signatures stored in the data store 110 including, for example, the acoustic signature 155A. The acoustic classification engine 110 may classify the recording 120 based at least on the recording 120 matching the acoustic signature 155A. When the recording 120 is determined to match the acoustic signature 155A, the acoustic classification engine 110 (e.g., the classification engine 114) may determine that the recording 120 is associated with the same classification 155B associated with the acoustic signature 155A. Alternatively and/or additionally, the acoustic classification engine 110 can classify the recording 120 based at least on the recording 120 failing to match any of the acoustic signatures stores in the data store 110. In this case, the acoustic classification engine 110 can determine that the recording 120 is unclassified and/or detect an absence of sounds corresponding to the acoustic signatures found in the data store 150.

The acoustic classification system 10 may perform, based at least on the classification of the sound, one or more corresponding actions (408). For instance, the acoustic classification engine 110 (e.g., the response module 116) may perform and/or trigger the performance of one or more actions (e.g., the first action 155C and/or the second action 155D) corresponding to the classification of the sound (e.g., as determined by the classification module 114 at operation 404). For instance, the acoustic classification engine 110 may perform and/or trigger the performance of actions corresponding to the sound being classified as dog barking and/or infant crying. As shown in FIGS. 2-3, the classification of the sound may correspond to a feedback class (e.g., unclassified, public, private, personal). As such, in some implementations of the current subject matter, the acoustic classification engine 110 may perform and/or trigger the performance of one or more actions corresponding to the feedback class associated with the classification of the sound. These actions may include providing an alert to the user and/or a third party. Alternately and/or additionally, these actions may include adjusting the sound modifications that can be applied to the sound.

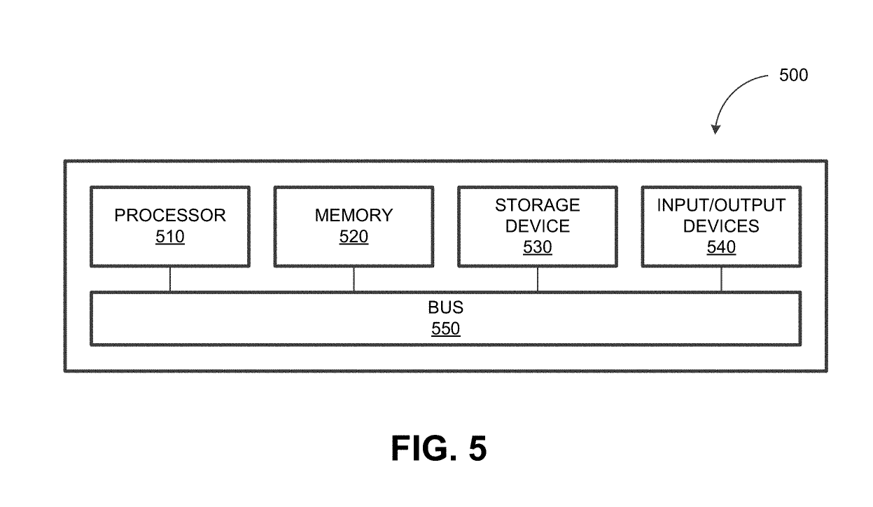

FIG. 5 depicts a block diagram illustrating a computing system 500 consistent with implementations of the current subject matter. Referring to FIGS. 1 and 5, the computing system 500 can be used to implement the acoustic classification engine 110 and/or any components therein.

As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The processor 510 is capable of processing instructions for execution within the computing system 500. Such executed instructions can implement one or more components of, for example, the acoustic classification engine 110. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various formats. Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results.

Other implementations may be within the scope of the following claims.

What is claimed is:

1. A computer-implemented method, comprising:
generating, based at least on one or more user inputs, a first association between a first acoustic signature and a first classification, the generation of the first association including storing, at a database, the first association between the first acoustic signature and the first classification;
generating, based at least on the one or more user inputs, a second association between the first classification and a first action, the generation of the second association including storing, at the database, the second association between the first classification and the first action;
determining, by at least on data processor, that a first sound is associated with the first classification based at least on the first sound matching the first acoustic signature; and
in response to the first sound being associated with the first classification, performing the first action associated with the first classification.

2. The method of claim 1, wherein the first acoustic signature comprises a first audio waveform, and wherein the determination that the first sound is associated with the first classification comprises comparing a second audio waveform of the first sound against the first audio waveform of the first acoustic signature.

3. The method of claim 1, further comprising:
determining that the first sound is associated with a second classification based at least on the first sound failing to match the first acoustic signature; and
in response to the first sound being associated with the second classification, performing a second action.

4. The method of claim 3, wherein the second classification designates the first sound as being unclassified, and wherein the second action comprises disregarding the first sound.

5. The method of claim 3, wherein the first sound is determined to be associated with the second classification further based at least on the first sound matching a second acoustic signature associated with the second classification, and wherein the second action is associated with the second classification.

6. The method of claim 1, further comprising:
detecting, based at least on the first sound failing to match the first acoustic signature, an absence of a second sound corresponding to the first acoustic signature; and
in response to detecting the absence of the second sound, performing a second action, the second action comprising triggering, at a device, an alert indicating the absence of the second sound.

7. The method of claim 1, wherein the first action comprises triggering, at a device, an alert indicating a presence of the first sound, and wherein the alert comprises a visual alert, an audio alert, and/or a haptic alert.

8. The method of claim 1, wherein the first action comprises triggering, at a device, a modification of the first sound, and wherein the modification comprises amplification, padding, and/or dynamic range compression.

9. The method of claim 1, wherein the first action comprises sending, to a device, a push notification, an email, and/or a short messaging service (SMS) text message.

10. The method of claim 1, further comprising:
generating, based at least on the one or more user inputs, a third association between the first classification and a second action; and
in response to the first sound being associated with the first classification, performing the first action at a first device and performing the second action at a second device.

11. A system, comprising:
at least one data processor:
at least one memory storing instructions which, when executed by the at least one data processor, result in operations comprising:
generating, based at least on one or more user inputs, a first association between a first acoustic signature and a first classification, the generation of the first association including storing, at a database, the first association between the first acoustic signature and the first classification;
generating, based at least on the one or more user inputs, a second association between the first classification and a first action, the generation of the second association including storing, at the database, the second association between the first classification and the first action;
determining, by at least on data processor, that a first sound is associated with the first classification based at least on the first sound matching the first acoustic signature; and
in response to the first sound being associated with the first classification, performing the first action associated with the first classification.

12. The system of claim 11, wherein the first acoustic signature comprises a first audio waveform, and wherein the determination that the first sound is associated with the first classification comprises comparing a second audio waveform of the first sound against the first audio waveform of the first acoustic signature.

13. The system of claim 11, further comprising:
determining that the first sound is associated with a second classification based at least on the first sound failing to match the first acoustic signature; and
in response to the first sound being associated with the second classification, performing a second action.

14. The system of claim 13, wherein the second classification designates the first sound as being unclassified, and wherein the second action comprises disregarding the first sound.

15. The system of claim 13, wherein the first sound is determined to be associated with the second classification further based at least on the first sound matching a second acoustic signature associated with the second classification, and wherein the second action is associated with the second classification.

16. The system of claim 11, further comprising:
detecting, based at least on the first sound failing to match the first acoustic signature, an absence of a second sound corresponding to the first acoustic signature; and
in response to detecting the absence of the second sound, performing a second action, the second action comprising triggering, at a device, an alert indicating the absence of the second sound.

17. The system of claim 11, wherein the first action comprises triggering, at a device, an alert indicating a presence of the first sound, and wherein the alert comprises a visual alert, an audio alert, and/or a haptic alert.

18. The system of claim 11, wherein the first action comprises triggering, at a device, a modification of the first sound, and wherein the modification comprises amplification, padding, and/or dynamic range compression.

19. The system of claim 11, wherein the first action comprises sending, to a device, a push notification, an email, and/or a short messaging service (SMS) text message.

20. A non-transitory computer program product storing instructions, which when executed by at least one data processor, result in operations comprising:
generating, based at least on one or more user inputs, a first association between a first acoustic signature and a first classification, the generation of the first association including storing, at a database, the first association between the first acoustic signature and the first classification;
generating, based at least on the one or more user inputs, a second association between the first classification and a first action, the generation of the second association including storing, at the database, the second association between the first classification and the first action;
determining, by at least on data processor, that a first sound is associated with the first classification based at least on the first sound matching the first acoustic signature; and
in response to the first sound being associated with the first classification, performing the first action associated with the first classification.
